(19) United States
(12) Patent Application Publication
(10) Pub. No.: US 2008/0234931 A1
(43) Pub. Date: Sep. 25, 2008

(54) ELECTRONIC DEVICE FOR INDICATING POI ACCORDING TO ROAD SEGMENT AND METHOD THEREOF

(76) Inventors: Chun-Yan Wang, Hefei (CN); Jie Chen, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/049,368

(22) Filed: Mar. 16, 2008

(30) Foreign Application Priority Data
Mar. 20, 2007 (CN) 200710089142.X

(51) Int. Cl. G01C 21/36

(52) U.S. Cl. 701/209

(57) ABSTRACT

An electronic device for indicating a POI corresponding to a new road segment when arriving at the new road segment includes an interface unit, for providing a setting of the POI to be displayed; a positioning system, for identifying the position of the electronic device; and a processor, for determining whether the electronic device is arriving at a new road segment according to the position of the electronic device, and retrieving information of a specific POI corresponding to the new road segment from a database if the electronic device is arriving at the new road segment, wherein the electronic device accesses the database and transmits the specific POI to the interface unit to indicate to a user only when it arrives at the new road segment.

### BACKGROUND OF THE INVENTION

1. Field of the Invention

The present invention relates to an electronic device for indicating a point of interest (POI) and a method thereof, and more particularly, to an electronic device for indicating a POI corresponding to a new road segment when arriving at the new road segment and the method thereof.

2. Description of the Prior Art

A general vehicle navigation system or a navigation system integrated into a portable device (such as a cell phone, PDA, etc.) is commonly combined with an electronic map to provide users with precise positioning and road inquiry functions. As travel becomes increasingly popular, navigation systems are providing more and more advanced services. For example, users can search for properties including name, address and phone number of a POI (e.g. a shop, gas station, hospital, landmark, or museum) in a target area. Users can also determine criteria for displaying points of interest, for example by category or selecting the maximum distance within which to search POIs, and this information is then shown on the electronic map. Moreover, the navigation system can plan a route from the present position to a POI selected by the user, display a detailed map as the user moves forward, and estimate the required time to arrive at the POI according to the present speed. Generally speaking, when indicating POIs, the navigation system first calculates the user's coordinates by utilizing a positioning system, e.g. Global Positioning System (GPS), and then searches a database according to those coordinates to find information corresponding to the POI search criteria set by the user. Whenever the user moves so that the coordinates change, the navigation system searches the database according to the new coordinates again.

Although the above navigation system seems to be feature-rich, it is still only reactive to user commands as needed. That is, the conventional navigation system can only passively provide relating information when the user inquires; it cannot automatically remind or indicate when the user is approaching the destination or target POI. Therefore, if the user is not familiar with the traffic situation or place names, he/she may miss or pass by the destination or target POI without realizing it.

### SUMMARY OF THE INVENTION

One objective of the present invention is to provide an electronic device for indicating a POI corresponding to a new road segment when arriving at the new road segment and the method thereof. Whenever the user arrives at a new road segment, the electronic device of the present invention automatically searches POIs corresponding to the new road segment in a database and indicates the POI. Therefore, the present invention can improve upon the drawbacks of the prior art. Please note that the electronic device of the present invention only reads the database when arriving at a new road segment.

According to an exemplary embodiment of the present invention, an electronic device for indicating a POI is disclosed. The electronic device comprises an interface unit, for providing desired settings for displaying POIs; a positioning system, for identifying the position of the electronic device; and a processor, coupled to a database, the interface unit and the positioning system, for determining whether the electronic device is arriving at a new road segment according to the current location of the electronic device, retrieving information of a specific POI corresponding to the new road segment from the database and transmitting the specific POI to the interface unit to indicate if the electronic device is arriving at a new road segment.

According to another exemplary embodiment of the present invention, a method of reminding the user of a POI on an electronic device is disclosed, wherein the information of the POI is stored in a database. The method comprises identifying the position of the electronic device; determining whether the electronic device is arriving at a new road segment according to the position of the electronic device; when the electronic device arrives at the new road segment, retrieving information of a specific POI corresponding to the new road segment from the database and indicating the specific POI.

Compared with the prior art, when the user arrives at a new road segment, the electronic device of the present invention can automatically search the database for POIs corresponding to the new road segment according to preset criteria, and indicate the POIs. The user needs not repeatedly query for POIs, thereby saving time and improving convenience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an electronic device according to an exemplary embodiment of the present invention.

FIG. 2 is a flow chart of a method for indicating a POI on an electronic device according to an exemplary embodiment of the present invention.

FIG. 3 is a diagram showing an example of a settings interface of the electronic device of FIG. 1.

FIG. 4 is a diagram of different search ranges determined by the electronic device of FIG. 1 when searching the POI.

FIG. 5 is a diagram showing an example of an indication interface of the electronic device of FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

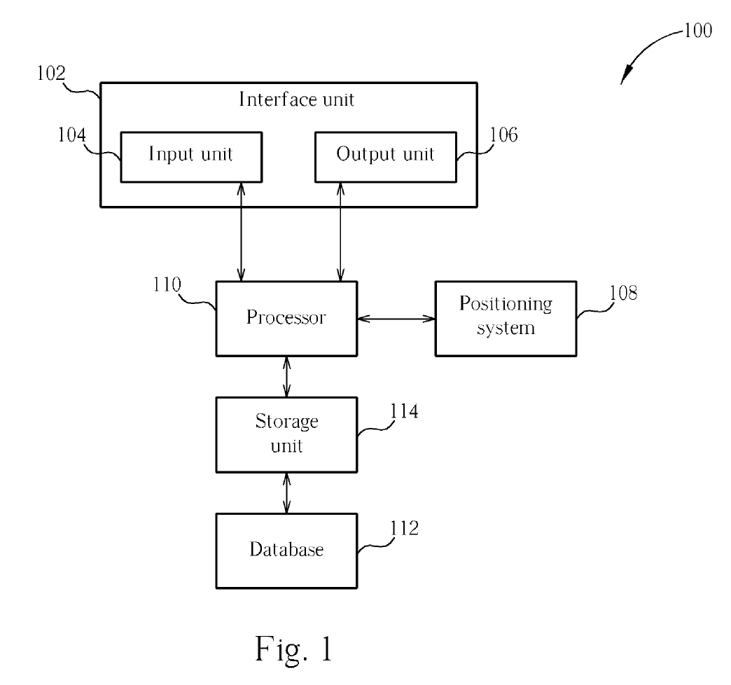

The present invention provides an electronic device for indicating a point of interest (POI) and can be implemented in a navigation system to automatically indicate an adjacent POI in a mode of transportation (a car, for example) or on a portable mobile device, and a method thereof. Please note that to implement the disclosed mechanism in a navigation system is only an example, and is not meant to be a limitation of the present invention. FIG. 1 is a diagram of an electronic device according to an exemplary embodiment of the present invention. The electronic device 100 comprises an interface unit 102, and the interface unit 102 comprises an input unit 104 and an output unit 106. The input unit 104 is for a user to set up the criteria for POIs to be indicated, such as the POI's category or the maximum distance to the POI from a road segment. The implementation methods of the input unit 104 can be an audio cue (such as an audio signal), visual cue (such as a video signal), or a combination thereof. For example, it can be a touch-sensitive screen, a keyboard, microphone or any other design able to input data. On the other hand, the output unit 106 is for indicating information by an audio cue, visual cue, or a combination thereof; it is therefore a video outputting device, image outputting device, or a combination thereof. For example, the output unit 106 can be a monitor, a speaker or any other design able to output information. In this embodiment, the ways of indication include by sound, words, pictures or images, etc. The electronic device 100 further comprises a positioning system 108 and a database 112. The positioning system 108 utilizes global navigation satellite system (GNSS, such as GPS), a dead reckoning system or a combination thereof to identify the position, direction and speed of the electronic device 100. The database 112 stores information of a plurality of POIs and geographic information required to show a map. It should be noted that although the database 112 is built inside the electronic device 100 in this embodiment, in another embodiment of the present invention the database 112 can be built outside the electronic device 100, and the electronic device 100 can remotely access the database 112 through wireless transmission. This alternative design also falls within the scope of the present invention. As shown in FIG. 1, a storage unit 114 is coupled to the database 112, and is for storing the criteria of the POI to be indicated, which is set by the user via the input unit 104, as well as for storing the information retrieved from the database 112 to be shown by the output unit 106. A processor 110 is coupled to the storage unit 114, the input unit 104, the output unit 106 and the positioning system 108, and is for processing the geographic information in the storage unit 114 to show an electronic map and indicating the POI, planning the route and providing navigation instructions according to the positioning result of the positioning system 108. When indicating the POI, the processor 110 first determines whether the electronic device 100 has arrived at a new road segment according to the positioning result of the positioning system 108, and when the electronic device 100 arrives at a new road segment, the processor 110 retrieves the information of a specific POI matching the user's preset criteria and corresponding to the new road segment, wherein the road segment means a length of road between two adjacent intersections. In this embodiment, the processor 110 only accesses the database 112 and transmits the specific POI to the output unit 106 of the interface unit 102 when arriving at a new road segment.

The map displaying, POI indicating, route planning and navigation instructing functions mentioned above are for illustrative purposes only and are not meant to be a limitation of the present invention. Other additional functions that a skilled person can readily appreciate after reading the disclosure of the present invention shall also belong to the scope of the present invention. Furthermore, since the techniques of the interface system, the positioning system, the displaying of electronic map, the route planning and the navigation instruction are well known to those skilled in the art, further description is omitted here for brevity.

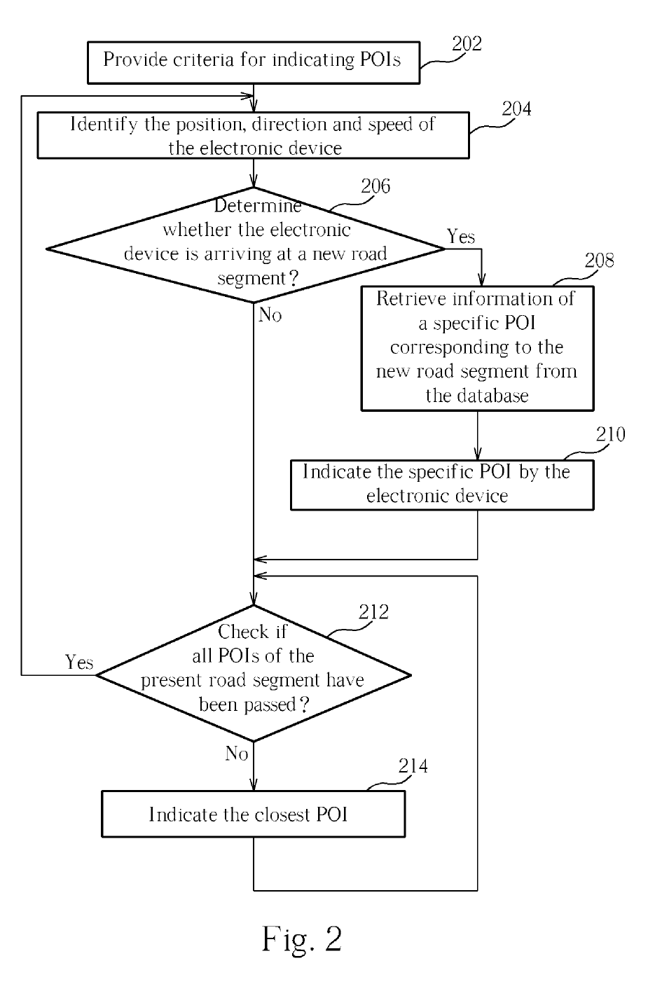

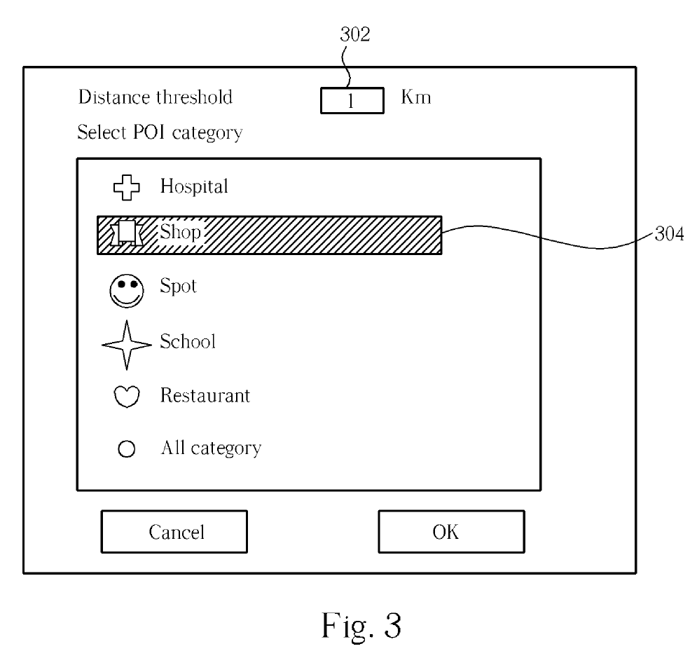

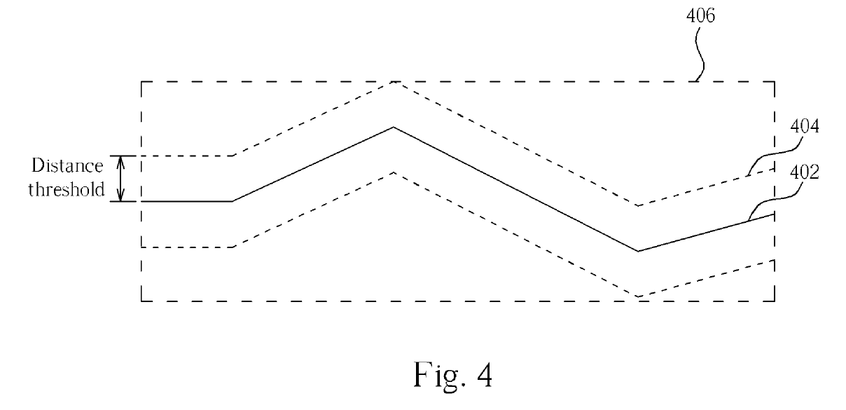

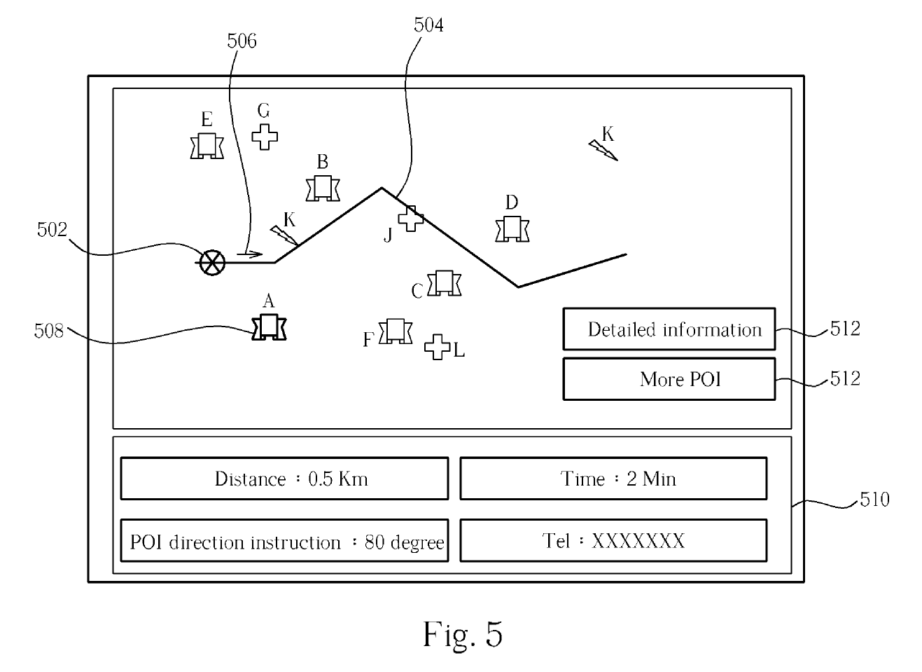

Please refer to FIG. 2 through FIG. 5 in conjunction. FIG. 2 is a flowchart of a method for indicating a POI on the electronic device 100 according to an exemplary embodiment of the present invention. FIG. 3 is a diagram showing an example of a settings interface on the electronic device 100. FIG. 4 is a diagram of different search ranges set by the electronic device 100 when searching the database for POIs. FIG. 5 is a diagram showing an example of an indication interface of the electronic device 100. In FIG. 2, step 202 provides criteria for indicating POIs by the output unit 104, such as the POI's category and a distance threshold from the current road segment to the POI. As shown in FIG. 3, the user can enter the desired distance threshold in an input frame 302. For example, when 1 Km is entered, the electronic device 100 will only indicate points of interest located within a distance of 1 km from the current road segment location of the electronic device 100; when 0 km is entered, the electronic device 100 will not indicate any POI. In addition, the user can select the category of POI by moving a selecting frame 304. When “Shop” is selected, the electronic device 100 will only show the POI belonging to the “shop” category. These settings are stored in the storage unit 114. Then the positioning system 108 identifies the position, direction and speed (step 204), and the processor 110 checks the database 112 according to the position of the electronic device 100 to determine whether the electronic device 100 is arriving at a new road segment (step 206).

If the electronic device 100 arrives at a new road segment, the process goes to step 208, retrieving information of a specific POI corresponding to the new road segment from the database 112. In step 208, the processor 110 determines a search area by extending the new road segment by the distance threshold, retrieves information for POIs inside the search area and matches the POI category preset by the user, and then stores the information in storage unit 114. Referring to FIG. 4, dotted line 404 represents an example of the search area, an area formed by extending the new road segment 402 the distance threshold, and dotted line 406 represents another example, in which a minimum rectangular coordinate area includes the dotted line 404. Please note that in some specific situations, a minimum square coordinate area is also an embodiment of the disclosed minimum rectangular coordinate area since a square is one type of rectangle. The computing complexity of the processor 110 to search the database 112 according to the search area 406 is lower than according to the search area 404 because of the regular (rectangular) shape of search area 406. In addition, most POIs (such as shops and restaurants) are located near roads, so most POI inside search area 406 would also be within search area 404. This makes the above searching reasonable since the search result will not differ much from the user's distance threshold setting. After the information of the specific POI is retrieved, the specific POI is indicated by the output unit 106 (step 210). As shown in FIG. 5, the present position 502, the road segment 504, the moving direction 506 of the electronic device 100 and the specific POI 508 are displayed. If the POI 508 is the closest POI to the present position 502, it is specially marked or highlighted in some manner, and its information is shown in the frame 510 below. Furthermore, by selecting other operating buttons 512, the user can obtain detailed information of the specific POI 508 or of another POI.

If the electronic device 100 does not arrive at a new road segment, however, the processor 110 will not access database 112, and instead checks if all POIs of the present road segment have been passed according to the position and direction of the electronic device 100 (step 212). If not all POIs of the present road segment are passed, the closest POI is indicated through the output unit 106 (step 214), and the process returns to step 212 until there are no POIs in this road segment still ahead. When all POIs of this road segment are passed by, the process returns to step 204 until the user stops it. Note that the user can stop the process or enter step 202 to reset the POI criteria settings at any time.

To conclude, after the user sets the point of interest criteria (i.e. category and distance threshold, etc.) in electronic device 100, each time when the user arrives at a new road segment (that is, the electronic device 100 and the user arrive at a new road segment), the electronic device 100 searches for POIs corresponding to the new road segment, matches the predetermined conditions in the database 112 and indicates the POI automatically. It should be noted that only when arriving at a new road segment will the electronic device 100 access the database 112, which means that the POI search only takes place once for each road segment. In this way, the present invention can automatically indicate to the user the nearest specific POI and improves upon the drawbacks of conventional navigation systems, thereby making travel easy and free.

Those skilled in the art will readily observe that numerous modifications and alterations of the device and method may be made while retaining the teachings of the invention.

What is claimed is:

1. A method of indicating a point of interest (POI) on an electronic device, wherein information of the POI is stored in a database; the method comprising:
identifying a position of the electronic device;
determining whether the electronic device arrived at a new road segment according to the position of the electronic device;
when the electronic device arrives at the new road segment, retrieving information of a specific POI corresponding to the new road segment from the database; and
indicating the specific POI on the electronic device.

2. The method of claim 1, further comprising providing a setting of a POI to be indicated;
wherein the setting comprises a distance threshold from a road segment to the POI to be indicated; and the step of retrieving information of the specific POI corresponding to the new road segment from the database comprises:
determining a search area by extending the new road segment according to the distance threshold; and
retrieving information of a POI located within the search area from the database.

3. The method of claim 2, wherein the search area is a minimum rectangular coordinate area containing an area formed by extending the new road segment according to the distance threshold.

4. The method of claim 1, wherein the step of identifying the position of the electronic device comprises:
identifying the position of the electronic device according to a global navigation satellite system (GNSS) or a dead reckoning system.

5. The method of claim 1, wherein the road segment is an area of a road between two adjacent intersections of the road.

6. The method of claim 1, wherein the step of indicating the specific POI on the electronic device comprises:
when the specific POI is a POI closest to the position of the electronic device, indicating the information of the specific POI.

7. The method of claim 1, wherein the step of indicating the specific POI comprises indicating the specific POI by audio cue.

8. The method of claim 1, wherein the step of indicating the specific POI comprises indicating the specific POI by visual cue.

9. The method of claim 1, wherein the step of indicating the specific POI comprises indicating the specific POI by audio and visual cues.

10. The method of claim 1, being implemented in a navigation system.

11. An electronic device for indicating a POI, comprising:
an interface unit, for providing a setting of a POI to be indicated;
a positioning system, for identifying a position of the electronic device; and
a processor, coupled to a database, the interface unit and the positioning system, for determining whether the electronic device arrives at a new road segment according to the position of the electronic device; wherein when the electronic device arrives at the new road segment, the processor retrieves information of a specific POI corresponding to the new road segment from the database, and transmits the information of the specific POI to the interface unit for indicating the specific POI.

12. The electronic device of claim 11, wherein the setting of a POI to be indicated comprises a distance threshold from the POI to be indicated to a road segment; and the processor determines a search area by extending the new road segment according to the distance threshold, and retrieves information of a POI located within the search area from the database.

13. The electronic device of claim 12, wherein the search area is a minimum rectangular coordinate area containing an area formed by extending the new road segment according to the distance threshold.

14. The electronic device of claim 11, wherein the positioning system utilizes a global navigation satellite system (GNSS) or a dead reckoning system.

15. The electronic device of claim 11, wherein the road segment is an area of a road between two adjacent intersections of the road.

16. The electronic device of claim 11, wherein the processor further controls the interface unit to further indicate information of a POI closest to the position of the electronic device.

17. The electronic device of claim 11, wherein the interface unit indicates the specific POI by audio cue.

18. The electronic device of claim 11, wherein the interface unit indicates the specific POI by visual cue.

19. The electronic device of claim 11, wherein the interface unit indicates the specific POI by audio and video cues.

20. The electronic device of claim 11, being implemented in a navigation system.
